(19) United States
(12) Patent Application Publication
(10) Pub. No.: US 2012/0325781 A1
(43) Pub. Date: Dec. 27, 2012

(54) PROTECTIVE ENCLOSURE

(75) Inventors: Ryan M. Gneiting, Dubuque, IA (US); Allen M. Kennicker, Sherrill, IA (US)

(73) Assignee: DEERE & COMPANY, Moline, IL (US)

(21) Appl. No.: 13/167,289

(22) Filed: Jun. 23, 2011

(51) Int. Cl. B23K 11/00; B65D 71/00

(52) U.S. Cl. 219/78.01; 206/223

(57) ABSTRACT

The present disclosure provides a system for carrying out a welding process. The system includes a controllable robot having a robotic arm and a welding device coupled to the robotic arm. The welding device is configured to perform the welding process. The system also includes a housing coupled to the robotic arm adjacent the welding device and a closure member pivotably coupled to one end of the housing. The closure member is adapted to pivot between an open position and a closed position. A camera is disposed in the housing and removably coupled thereto. The camera has a lens oriented towards the closure member. The system further includes a light source disposed in the housing and removably coupled thereto such that the light source is disposed adjacent to the camera. During the welding process, the camera and light source are enclosed by the housing and closure member.

### FIELD OF THE INVENTION

The present invention relates to a protective enclosure, and in particular to a protective enclosure for protecting electronic devices in an extreme welding environment.

### BACKGROUND OF THE INVENTION

Welding is a well-known fabrication process for joining two or more materials, e.g., metals or thermoplastics. Welding often takes place in an industrial setting and uses a gas flame, an electric arc, a laser, an electron beam, friction or ultrasound as an energy source. The welding process can be hazardous and care is taken to avoid burns, electric shock, vision damage, inhalation of poisonous gases and fumes, and exposure to intense ultraviolet radiation.

In industrial settings, many functions can be performed by a robot or the like. This is advantageous for several reasons. First, it is safer having a robot carry out dangerous functions rather than a human being. Second, the robot can often work autonomously for many hours, days, or weeks without stopping. Robots are used in many industrial settings and improved technology has increased the functionality and efficiency of the robot.

In welding, robots are often used for many of the previously-described reasons. However, often it is desirable to observe the welding process being performed by the robot. Since the robot continuously moves during the welding process, it often difficult to monitor or visualize the welding process. Further, smoke, dust, fumes, and spatter can often be emitted during the welding process which further blurs or blocks one from observing the process. Video equipment can be used to record the process, but the emissions from the process itself often makes it difficult to clearly see the welding or the finished product. In addition, industrial settings can often be dark and the lack of a light source directed onto the welded materials further inhibits an observer from visualizing the welding process or the finished product.

Some industrial settings include cameras disposed in the corner of a welding room, for example, to monitor the process. Again, the emitted smoke, dust, fumes, and spatter obscure the process.

A need therefore exists to provide a means for visualizing and recording a welding process or finished product from the welding process and to protect equipment in close proximity to the welding process. There is also a need for providing both vision and lighting equipment at or near the welding without limiting the movement or functionality of a robot performing the welding.

### SUMMARY

In an exemplary embodiment of the present disclosure, a system is provided for carrying out a welding process. The system includes a controllable robot having a robotic arm and a welding device coupled to the robotic arm. The welding device is configured to perform the welding process. The system also includes a housing coupled to the robotic arm adjacent the welding device and a closure member pivotably coupled to one end of the housing. The closure member is adapted to pivot between an open position and a closed position. A camera is disposed in the housing and removably coupled thereto. The camera has a lens oriented towards the closure member. The system further includes a light source disposed in the housing and removably coupled thereto such that the light source is disposed adjacent to the camera. During the welding process, the camera and light source are enclosed by the housing and closure member.

In one aspect of this embodiment, the system can include a front access panel removably coupled to the front end of the housing. In another aspect, the system can include an access panel removably coupled to the housing at an end opposite the closure member. In a different aspect, the system includes a transparent member coupled to the housing adjacent the closure member. The camera and light source can be enclosed by the housing and transparent member in the open position.

The system can also include a foam layer coupled to the closure member, the foam layer being compressed between the closure member and transparent member in the closed position. The foam layer can form a seal between the closure member and housing in the closed position. The system can further include a cylinder having an elongated member movably coupled to the closure member, the elongated member movable in a substantially linear direction between a retracted position and an extended position; wherein, the closure member is in the closed position when the elongated member is in the retracted position, and the closure member is in the open position when the elongated member is in the extended position.

In another embodiment, a vision enclosure assembly is provided for use in a welding environment. The enclosure assembly includes a housing having a top panel, a bottom panel, a side panel, a front panel, and a back panel. The enclosure also includes a closure member pivotably coupled to the housing, the closure member adapted to pivot between an open position and a closed position. A bracket is coupled to the back panel of the housing, the bracket configured to couple to a robotic arm. The enclosure further includes an image-recording device disposed within the housing and coupled thereto, the image-recording device including a lens oriented towards the bottom panel. A light source is disposed within the housing and coupled thereto, the light source being disposed adjacent the image-recording device and configured to emit light in a direction towards the bottom panel. The top panel, bottom panel, side panel, front panel, and back panel each have a longest dimension less than about six inches.

In a related embodiment, the front panel and top panel can be removably coupled to the housing. Also, the bottom panel is at least partially transparent. The bottom panel can also be fixedly coupled to the housing.

In one aspect of this embodiment, the bottom panel and the closure member are substantially parallel to one another in the closed position. In another aspect, the bottom panel and the closure member are substantially perpendicular to one another in the open position. In addition, the image-recording device and light source can be substantially enclosed by the housing in the open and closed positions. The enclosure assembly can further include a seal coupled to the closure member. The seal can be compressed between the closure member and bottom panel in the closed position. The enclosure assembly can also include a cylinder having an elongated member coupled to the closure member. The elongated member can be movable between a retracted position in which the closure member is in the closed position and an extended position in which the closure member is in the open position.

In a different embodiment, an enclosure is provided for recording images during a welding process. The enclosure includes a housing having a top panel, a bottom panel, a pair of side panels, a front panel, and a back panel; a bracket coupled to the back panel of the housing, the bracket configured to couple to a robotic arm; a closure member pivotably coupled to the housing, the closure member adapted to pivot between an open position and a closed position; means for recording an image disposed within the housing; means for emitting light disposed within the housing; means for shuttering pivotably coupled to the housing, the means for shuttering adapted to pivot between an open position and a closed position; wherein, the means for recording and means for emitting are disposed adjacent to one another and oriented towards the means for shuttering.

In one aspect of this embodiment, the enclosure can include means for sealing coupled to the means for shuttering, wherein the means for sealing is disposed between the means for shuttering and the bottom panel in the closed position. In another aspect, the enclosure can include a first configuration and a second configuration, wherein in the first configuration, the means for shuttering is disposed in the open position, the means for recording is positioned to record an object visible through a transparent portion of the bottom panel, and the means for emitting is positioned to emit light through the transparent portion; and in the second configuration, the means for shuttering is disposed in the closed position and substantially covers the transparent portion. An object disposed outside the housing may or may not be visible through the transparent portion and means for shuttering in the second configuration, depending on the transparency of the means for shuttering.

In the present disclosure, the vision enclosure assembly provides an enclosure for protecting an image-recording device (e.g., camera) and a light source from smoke, dust, fumes, spatter, and temperature variation during a welding operation. As a result, the enclosure assembly can be disposed near the welding tool and video or pictures can be taken of a welded product with better images.

The enclosure assembly can be conveniently mounted to a robotic arm and thus positioned in an industrial setting for recording or producing images of the welding operation. A light source can advantageously emit light to allow for enhanced quality video or images to be recorded by the image-recording device. Further, the size of the enclosure panel is small enough so that the robotic arm does not have reduced mobility.

In addition, since the enclosure assembly can be mounted to a robotic arm in close proximity to the materials being welded, a robot can perform the welding without subjecting a human being to the hazards and risks associated with a normal welding process.

### BRIEF DESCRIPTION OF THE DRAWINGS

The above-mentioned aspects of the present invention and the manner of obtaining them will become more apparent and the invention itself will be better understood by reference to the following description of the embodiments of the invention, taken in conjunction with the accompanying drawings, wherein:

FIG. 1 is a perspective view of a robot performing a welding process;

FIG. 2 is a front perspective view of a vision enclosure;

FIG. 3 is a rear perspective view of the vision enclosure of FIG. 2;

FIG. 4 is a front perspective view of the vision enclosure of FIG. 2 with a front panel opened; and

FIG. 5 is a perspective view of a partially removed vision enclosure.

Corresponding reference numerals are used to indicate corresponding parts throughout the several views.

### DETAILED DESCRIPTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

In the present disclosure, an enclosure assembly is provided for use in any industrial or hazardous working environment. The enclosure assembly can be used especially in welding environments and be removably coupled to a robot that performs the welding. However, the enclosure assembly is not limited to welding environments and may also be useful for industrial painting environments, test cells, etc. The enclosure assembly is further suitable for housing equipment such as video recording devices, cameras, light sources, computers, audio recording devices, monitors, sensors and the like. The enclosure assembly may also be suitable for other uses such as being disposed on a traffic light pole. In such an example, a video camera may be attached thereto for recording traffic, pedestrians, etc.

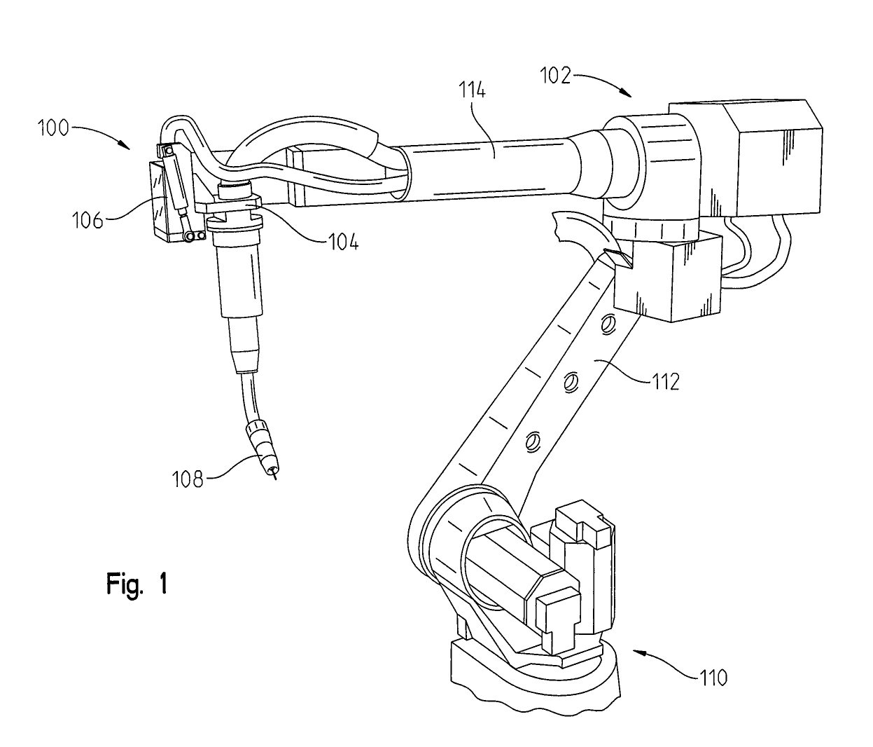

In one exemplary embodiment of the present disclosure, an industrial welding environment 100 is illustrated in FIG. 1. The environment 100 can be defined in a work cell, room, warehouse, industrial plant, garage, workshop, or other similar locations. In the environment 100, a robot 102 is positioned for carrying out a welding operation. The robot 102 can be a multi-axis robot having a plurality of axes (e.g., 2 or more axes). As shown, the robot 102 includes a base 110 which is mounted to a ground surface. The robot 102 further includes a first robotic member 112 and a second robotic member 114 connected to one another. A controllable robotic arm portion 104 is connected to the second robotic member 114 at an end opposite the first robotic member 112. The robotic arm portion 104 is such that a welding tool 108 or the like can be held or coupled at one end thereof. A plurality of welding tools 108 can be held or coupled to the robotic arm portion 104. The robot 102 can be any known, commercially-available industrial robot. One such example is an ARC Mate® 100iC/6L robot manufactured by FANUC Robotics America, Inc. The robot 102 can be electronically controlled, for example, to weld two or more materials together.

An enclosure assembly 106 is also shown in FIG. 1. The enclosure assembly 106 can be coupled to the robot arm 104. In this embodiment, the enclosure assembly 106 is coupled to one end of the robot arm 104 which is opposite the welding tool 108. The position or location at which the enclosure assembly 106 is coupled to the robot arm 104 can change based on the intended use and function of the assembly 106. For example, if a temperature sensor is being contained within the enclosure assembly 106 and its intended use is to detect the temperature of gases being emitted during the welding process, it may be desirable to position the enclosure assembly 106 at a location as close as possible to the welding tool 108. In other instances, however, it may be less desirable to position the enclosure assembly 106 near the welding tool. The design and connections of the enclosure assembly 106 can be adapted for coupling to the robotic arm 104 at a plurality of locations.

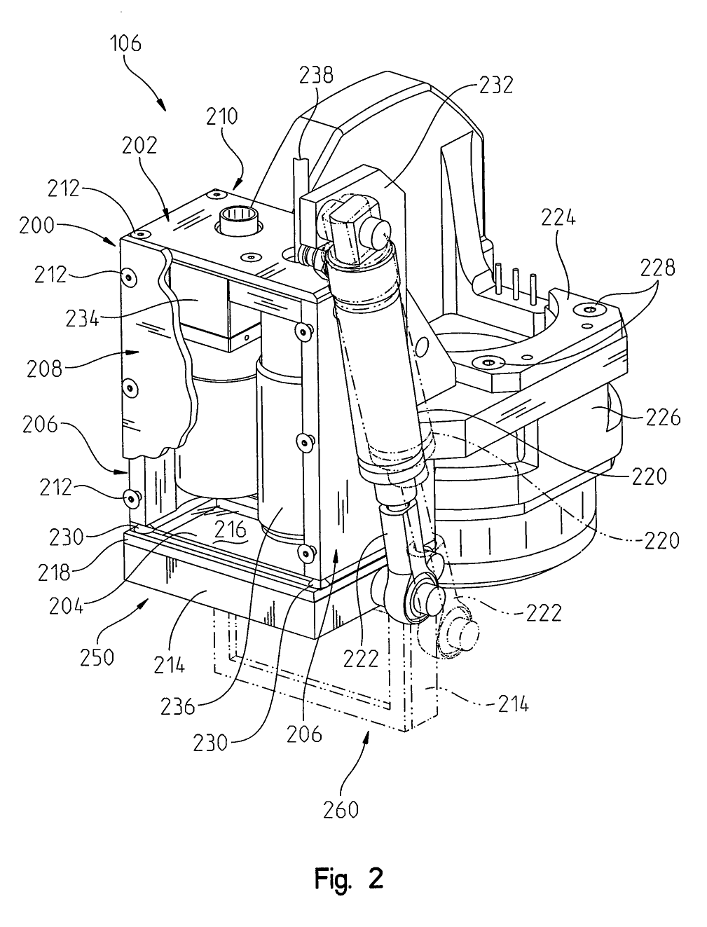

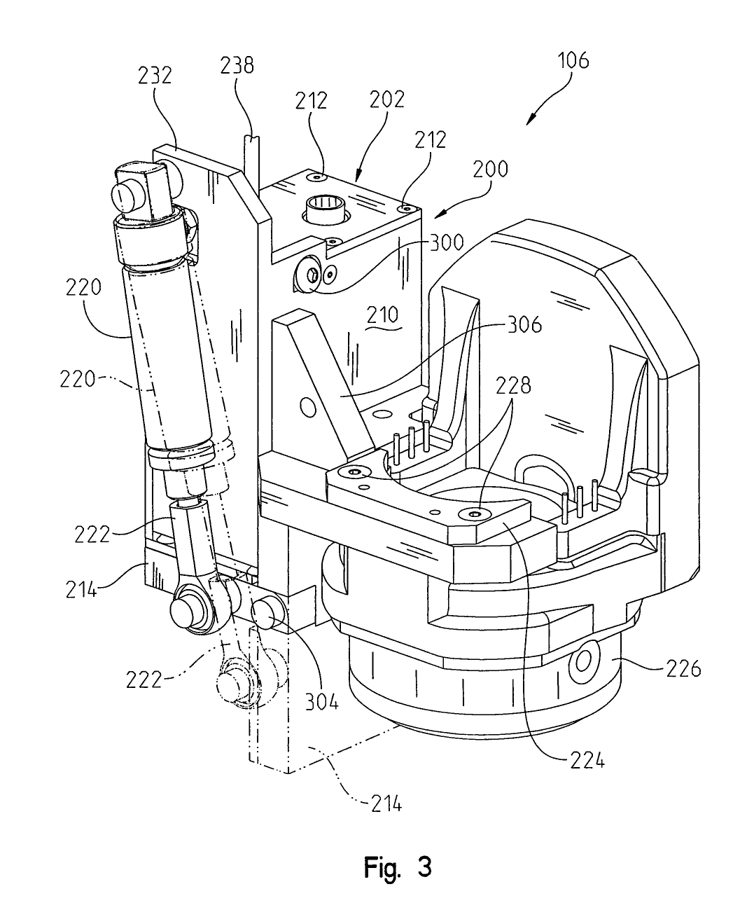

The enclosure assembly 106 will now be described in further detail. One example of an enclosure assembly is illustrated in FIGS. 2 and 3. Turning to FIG. 2, for example, the enclosure assembly 106 can include an outer housing 200. The housing 200 can be formed by a top panel 202, a bottom panel 204, side panels 206, a front panel 208 and a back panel 210. The top panel 202 and front panel 208 can be removably coupled to the housing 200. Fasteners such as screws or bolts 212 can be used for securing the top panel 202 and front panel 208 to the housing.

It can be desirable for the enclosure assembly 106 to be designed compactly so that when mounted to the robot arm 104, the enclosure assembly 106 does not limit the mobility or functionality of the robot 102. For instance, some functions carried out by a robot 102 may require a robot arm 104 to operate in narrow areas. Most conventional cameras or video equipment are too large to mount directly on the robot arm 104 in this instance and, if such equipment was mounted on the arm, the robot would be unable to flexibly maneuver in narrow or small areas. Thus, in the present disclosure, described embodiments of the enclosure assembly 106 desirably include a housing 200 having a top panel 202, a bottom panel 204, side panels 206, a front panel 208 and a back panel 210 in which the longest dimension of any or all of these panels is less than about 6 inches. In one exemplary embodiment, a housing 200 can include dimensions of about 3 inches×2 inches×6 inches. In most conventional enclosure assemblies, the longest dimension thereof is at least 8 or more inches and the utility of such an enclosure assembly is limited due to its size.

In FIGS. 2 and 3, the enclosure assembly 106 can also include a closure member 214 disposed near the bottom panel 204. The closure member 214 is pivotably coupled to the housing 200 near the back panel 210 via hinges or the like. As shown in FIG. 3, a hinge pin 304, e.g., bolt, screw, etc., can be used to secure the closure member 214 to the housing 200 and allow the closure member 214 to pivot thereabout. The closure member 214 is shown in two positions in FIGS. 2 and 3. First, the closure member 214 is shown in a closed position 250 in which it is parallel, or substantially parallel, to the top panel 202 and bottom panel 204. Second, the closure member 214 is also shown in an open position 260 in which it is substantially perpendicular to the top panel 202 and bottom panel 204. In the open position 260, the closure member 214 can be disposed substantially planar to the back panel 210. Further, the closure member 214 can be disposed substantially parallel to the front panel 208 and back panel 210 in the open position 260.

In one embodiment, the closure member 214 can have a transparent portion, or window, to allow objects to be visible therethrough. In this embodiment, the transparent portion has a suitable thickness so that debris does not break or damage the closure member 214. In another embodiment, the closure member 214 can be non-transparent such that objects cannot be visible therethrough.

The bottom panel 204 can include a transparent or semi-transparent portion. In one embodiment, the bottom panel 204 can be formed of a transparent, glass material 216 such that when the closure member 214 is disposed in the open position 260, the interior of the housing 200 is visible through the transparent material. In this instance, the bottom panel 204 functions as a window. In an alternative embodiment, the bottom panel 204 can be formed of a semi-transparent or opaque material. In a different embodiment, the bottom panel 204 can include a transparent portion and a non-transparent portion.

Each of the panels that define the housing 200 comprise a suitable thickness for placement in an industrial setting. Thus, during a welding or other industrial application, debris emitted from the application may contact the housing 200. The housing 200, however, is desirably designed to withstand such debris. Further, and not shown, the interior of the housing 200 can be temperature-controlled such that temperature-sensitive equipment can be stored or disposed therein. A temperature sensor and temperature control apparatus (e.g., a fan, heat sink, or heater) can be coupled to the housing 200 for such purposes.

The closure member 214 can be mechanically pivoted between the open position 260 and closed position 250, and any position therebetween, by a cylinder assembly 220. The cylinder assembly 220 can be controlled hydraulically, electronically, pneumatically, or by any other known method. The cylinder assembly 220 can include an elongated arm 222, or rod, that extends and retracts within the cylinder assembly 220. The arm 222 can be pneumatically controlled and coupled at one end thereof to the closure member 214. The cylinder assembly 220 can be coupled to a bracket or flange 232 that is planar or substantially parallel to the side panel 206. The bracket or flange 232, for example, can be an extension of the side wall 206, or alternatively, the bracket or flange 232 is integrally coupled to the side wall 206 of the housing 200. Thus, in the closed position 250, the elongated arm 222 is in a retracted position. In the open position 260, the elongated arm 222 is in an extended position.

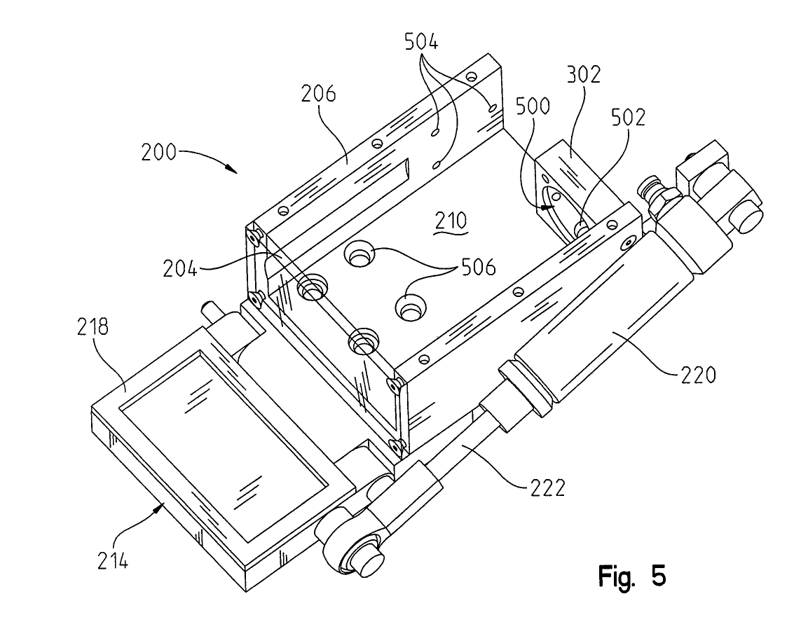

A second bracket 224 is shown in FIGS. 2 and 3 for coupling the housing 200 to a robot arm 226. The bracket 224 can be U-shaped for coupling to a cylindrical robot arm 226, or it can have a different design tailored to the size and shape of the arm 226. Further, the bracket 224 can define a plurality of apertures 228 through which fasteners can couple the bracket 224 to the robot arm 226. Referring to FIG. 3, another bracket or flange 306 can couple the housing 200 to the second bracket 224. The bracket or flange 306 can integrally coupled to the back panel 210 of the housing, for example, or fasteners can be used for the coupling. Other apertures 506 (see FIG. 5) defined in the back panel 210 of the housing 200 can be used for inserting fasteners (not shown) therethrough and coupling the housing 200 and bracket 224 to one another. The housing 200 can be removably coupled to the robot arm 226 via the bracket 224 so that the enclosure assembly 106 can be moved to different locations along the robot arm 226 or coupled to a different robot.

Referring to FIG. 2 again, a foam or compressible material 218 can be disposed on an interior surface of the closure member 214. The foam or compressible material 218 can be a flame resistant material that is coupled about the perimeter or circumference of the interior surface. For instance, the material 218 can be any elastic or foam material, or any material suitable for creating a seal. In an alternative arrangement, the foam or compressible material 218 can completely cover the interior surface of the closure member 214. The foam or compressible material 218, or layer, can be coupled to the closure member 214 in a plurality of ways. For instance, a plurality of fasteners 230 can couple the foam or compressible material 218 to the closure member 214. Alternatively, an adhesive can be used for the coupling. Other known methods can be used to achieve the coupling.

In the closed position 250, the foam or compressible material 218 can be compressed between the closure member 214 and bottom panel 204. Alternatively, the foam or compressible material 214 can be compressed between the closure member 214, bottom panel 204, side panels 206, front panel 208, or back panel 210, depending on the size of each panel. Since the foam or compressible material 214 is at least disposed about the perimeter or circumference of the interior surface of the closure member 214, the compression of the foam or compressible material 218 forms a seal between the interior of the housing 200 and the outside environment. As a result, during a welding operation, for example, smoke, fumes, dust, spatter, etc. are unable to infiltrate the interior of the housing 200 due to the seal. The enclosure assembly 106 therefore provides ideal working conditions for electronic equipment and the like in hazardous or extreme industrial environments.

In FIG. 2, the enclosure assembly 106 is shown housing an image-recording device 234 and a light source 236. The light source 236 can include a cord or wire 238 for connecting to an electrical outlet. Alternatively, the light source 236 can be powered by a battery (not shown). The image-recording device 234 can be a video camera, a digital camera, a film-based camera, or any other known image-recording device. For example, the image-recording device 234 can be an XC-56 camera manufactured by Sony Electronics Inc. The light source 236 can be a flashlight, spot light, or any other known source for producing light. For instance, the light source 236 can be a Banner® LEDRSW spot light manufactured by Banner Engineering Corp.

The light source 236 can be removably coupled to the back panel 210 of the housing 200 by a fastener 300 (FIG. 3). The top panel 202 can include an aperture through which the light source 236 can be inserted for being disposed in the housing 200. A bracket or flange 302 can be coupled to the side wall 206 of the housing 200 and extend into the interior of the housing 200 such that the bracket or flange 302 is substantially parallel to the top panel 202 and bottom panel 204. The bracket or flange 302 further includes a sized opening 500 (see FIG. 5) for receiving the light source 236. The bracket or flange 302 can also include a second opening or aperture 502 that can threadedly receive the fastener 300 for coupling the light source 236 to the housing 200.

The image-recording device 234 can include a plurality of threaded apertures (not shown) for coupling to the side panel 206 of the housing 200. As shown in FIG. 5, the side panel 206 can comprise a plurality of apertures 504 through which fasteners such as screws (not shown) can be coupled to the threaded apertures defined in the image-recording device 234. As a result, the image-recording device 234 can be removed from the housing 200 so that recorded images can be removed from the device 234 and transferred to another media (e.g., computer, film, etc.).

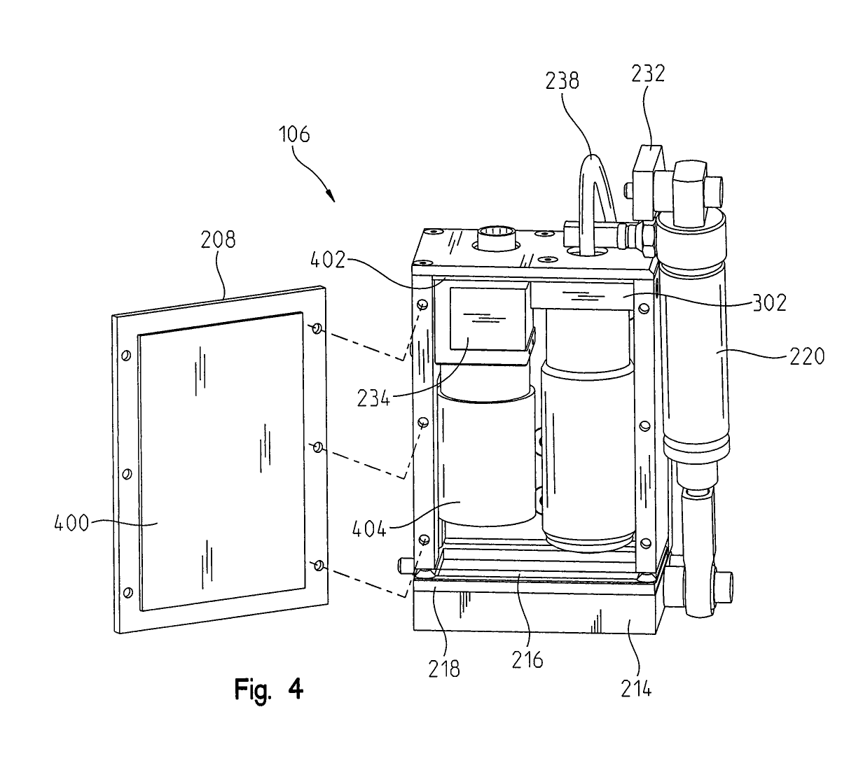

Referring to FIG. 4, the enclosure assembly 106 is shown with the front panel 208 being removed from the housing 200. The interior surface of the front panel 208 can include an insulating or compressible layer 400 similar to the compressible material 218 previously described. The insulating or compressible layer 400 can form a seal between the front panel 208, top panel 202, bottom panel 204, and side panels 206. The insulating or compressible layer 400 can be any flame resistant material that protects the image-recording device 234, light source 236, or any other device contained within the housing 200 from debris.

The top panel 202 can also include an insulating or compressible layer 402 similar to the material of the first insulating or compressible layer 400. The top panel 202 can also be removably coupled to the housing 200, and thus the insulating or compressible layer 402 can form a seal and protect the interior of the housing 200 from debris and other particulate matter in the surrounding environment. As shown, the insulating or compressible layer 402 can form a seal between the top panel 202, side panels 206, front panel 208, and back panel 210 when assembled.

In the arrangement shown in FIG. 4, the image-recording device 234 and light source 236 can be disposed in the housing 200 in a proximate side-by-side or adjacent relationship. Due to the relative small size of the enclosure assembly 106, the image-recording device 234 and light source 236 can occupy greater than 50% of the volume inside the housing 200. This again allows the enclosure assembly 106 to be small and not inhibit the mobility of a robot arm to which the enclosure assembly 106 may be coupled.

In addition, the image-recording device 234 can include a lens 404 that is oriented in a direction towards the bottom panel 204. The light source 236 can also be coupled to the housing 200 such that light emitted from the light source projects towards the bottom panel 204. Thus, in this embodiment, the closure member 214 can be disposed in the open position 260 to allow objects outside the housing to be visible to the image-recording device 234 and light source 236 through the transparent portion of the bottom panel 204. Images can be recorded by the image-recording device 234 and the light source can provide adequate light for the recorded images to be of suitable quality.

In a different embodiment, the front panel 208 can include a transparent portion through which objects can be visible to an image-recording device 234 or light source 236. In this arrangement, the image-recording device 234 and light source 236 are repositioned within the housing 200 to allow the objects to be viewed and images recorded. In alternative embodiments, other panels of the housing 200 (e.g., top panel 202, side panels 206, or back panel 210) can include transparent portions through which objects outside the housing can be visible to an image-recording device 234 enclosed within the housing 200. Additional structure in the housing 200 may allow the image-recording device 234 to be movable (e.g., rotated) to allow images to be recorded through these different panels. In this embodiment, a light source 236 or other device may not be disposed in the housing to allow for such movement of the image-recording device. Similarly, a light source 236 or other device may be disposed in the housing 200 and movable therein without an image-recording device 234 coupled to the housing. Any setup can be arranged in the enclosure assembly 106 to perform a desirable function during a welding or other process.

While exemplary embodiments incorporating the principles of the present invention have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

1. A system for carrying out a welding process, comprising:
a controllable robot having a robotic arm;
a welding device coupled to an end of the robotic arm, the welding device configured to perform the welding process;
a housing coupled to the robotic arm adjacent the welding device;
a closure member pivotably coupled to one end of the housing, the closure member adapted to pivot between an open position and a closed position;
a camera disposed in the housing and removably coupled thereto, the camera having a lens oriented towards the closure member; and
a light source disposed in the housing and removably coupled thereto, the light source being coupled adjacent to the camera;
wherein, during the welding process, the camera and light source are enclosed by the housing and closure member.

2. The system of claim 1, further comprising a front access panel removably coupled to the front end of the housing.

3. The system of claim 1, further comprising an access panel removably coupled to the housing at an end opposite the closure member.

4. The system of claim 1, further comprising a transparent member coupled to the housing adjacent the closure member.

5. The system of claim 4, wherein the camera and light source are enclosed by the housing and transparent member in the open position.

6. The system of claim 4, further comprising a compressible layer coupled to the closure member, the compressible layer being compressed between the closure member and transparent member in the closed position.

7. The system of claim 6, wherein the compressible layer forms a seal between the closure member and housing in the closed position.

8. The system of claim 1, further comprising a cylinder having an elongated member movably coupled to the closure member, the elongated member moving in a substantially linear direction between a retracted position and an extended position;
wherein, the closure member is in the closed position when the elongated member is in the retracted position, and the closure member is in the open position when the elongated member is in the extended position.

9. A vision enclosure assembly for use in a welding environment, comprising:
a housing having a top panel, a bottom panel, a side panel, a front panel, and a back panel;
a closure member pivotably coupled to the housing, the closure member adapted to pivot between an open position and a closed position;
a bracket coupled to the back panel of the housing, the bracket configured to couple to a robotic arm;
an image-recording device disposed within the housing and coupled thereto, the image-recording device including a lens oriented towards the bottom panel; and
a light source disposed within the housing and coupled thereto, the light source being disposed adjacent the image-recording device and configured to emit light in a direction towards the bottom panel;
wherein the top panel, bottom panel, side panel, front panel, and back panel each have a longest dimension that is less than about six inches.

10. The vision enclosure assembly of claim 9, wherein the front panel and top panel are removably coupled to the housing.

11. The vision enclosure assembly of claim 9, wherein the bottom panel is at least partially transparent.

12. The vision enclosure assembly of claim 9, wherein the bottom panel is fixedly coupled to the housing.

13. The vision enclosure assembly of claim 9, wherein the bottom panel and the closure member are substantially parallel to one another in the closed position.

14. The vision enclosure assembly of claim 9, wherein the bottom panel and the closure member are substantially perpendicular to one another in the open position.

15. The vision enclosure assembly of claim 9, wherein the image-recording device and light source are substantially enclosed by the housing in the open and closed positions.

16. The vision enclosure assembly of claim 9, further comprising a seal coupled to the closure member, the seal being compressed between the closure member and bottom panel in the closed position.

17. The vision enclosure assembly of claim 9, further comprising a cylinder having an elongated member coupled to the closure member, the elongated member being movable between a retracted position in which the closure member is in the closed position and an extended position in which the closure member is in the open position.

18. An enclosure for recording images during a welding process, comprising:
a housing having a top panel, a bottom panel, a pair of side panels, a front panel, and a back panel;
a bracket coupled to the back panel of the housing, the bracket configured to couple to a robotic arm;
means for recording an image disposed within the housing;
means for emitting light disposed within the housing; and
means for shuttering pivotably coupled to the housing, the means for shuttering adapted to pivot between an open position and a closed position;
wherein, the means for recording and means for emitting are disposed adjacent to one another and oriented towards the means for shuttering.

19. The enclosure of claim 18, further comprising means for sealing coupled to the means for shuttering, wherein the means for sealing is disposed between the means for shuttering and the bottom panel in the closed position.

20. The enclosure of claim 18, further comprising a first configuration and a second configuration, wherein:
in the first configuration, the means for shuttering is disposed in the open position, the means for recording is positioned to record an object visible through a transparent portion of the bottom panel, and the means for emitting is positioned to emit light through the transparent portion; and
in the second configuration, the means (214) for shuttering is disposed in the closed position (250) and substantially covers the transparent portion (216).
